(19) United States
(12) Patent Application Publication
(10) Pub. No.: US 2004/0162713 A1
(43) Pub. Date: Aug. 19, 2004

(54) Modeling pin depths associated with coaxial standards

(76) Inventors: David VerNon Blackham, Santa Rosa, CA (US); Kenneth H. Wong, Santa Rosa, CA (US); James R. Myers, Santa Rosa, CA (US)

Correspondence Address: AGILENT TECHNOLOGIES, INC ., Legal Department, DL429, Intellectual Property Administration, P.O. Box 7599, Loveland, CO, 80537-0599, US

(21) Appl. No.: 10/365,882

(22) Filed: Feb. 13, 2003

(51) Int. Cl. G06F 17/50

(52) U.S. Cl. 703/13

(57) ABSTRACT

A modeling method modifies a nominal model for a coaxial standard to provide an enhanced model for the coaxial standard. The nominal model is a nominal reflection coefficient that is phase rotated and impedance transformed to provide an enhanced reflection coefficient that represents the enhanced model. Alternatively, a transmission matrix for the coaxial standard is established and converted to an S-parameter matrix. The enhanced model is then extracted from the nominal model and the S-parameter matrix using network analysis techniques.

### FIELD OF THE INVENTION

This invention relates to network analysis, and particularly, to models of coaxial standards that are used to calibrate network analyzers.

### BACKGROUND OF THE INVENTION

Coaxial standards, such as open, short, thru and load standards are commonly used to calibrate network analyzers. Typically, response characteristics of the coaxial standards are measured by a network analyzer and combined with models of the response characteristics to solve for error correction terms that provide the calibration. This approach is used in many types of network analyzers, such as the model E8361A network analyzer, by AGILIENT TECHNOLOGIES, INC., of Palo Alto, Calif.

Limitations in manufacturing techniques cause connector terminations integral to the coaxial standards to have dimensions that vary from coaxial standard to coaxial standard. When these coaxial standards are mated with a test port, the dimensional tolerances result in pin depth variations that cause corresponding variations in the response characteristics of the coaxial standards—especially at high frequencies. Accurate calibration of a network analyzer using the coaxial standards relies on accommodating for the pin depth variations in the models of the coaxial standards.

Known approaches model the coaxial standards using a polynomial curve fit or a discrete data point fit with interpolation. However, at high frequencies the models do not accurately represent the effect of the pin depth variations on the response characteristics of the coaxial standards—even when high order polynomials or sophisticated interpolations are used to fit the response characteristics. In addition, these modeling approaches do not isolate the effect of the pin depth on the response characteristics of the coaxial standards, which makes it difficult to modify the models to accommodate for the variations in the pin depths. Accordingly, there is a need for a modeling method that accommodates for variations in pin depths associated with the coaxial standards so that accurate calibration of a network analyzer can be performed using the coaxial standards.

### SUMMARY OF THE INVENTION

A modeling method constructed according to the embodiments of the present invention modifies a nominal model for a coaxial standard to provide an enhanced model for the coaxial standard that accurately represents the response characteristics of the coaxial standard. According to one embodiment, the nominal model is a nominal reflection coefficient that is phase rotated and impedance transformed to provide an enhanced reflection coefficient that represents the enhanced model. According to alternative embodiments, a transmission matrix for the coaxial standard is established and converted to a corresponding S-parameter matrix. The enhanced model is then extracted from the nominal model and the S-parameter matrix using network analysis techniques.

### BRIEF DESCRIPTION OF THE DRAWINGS

FIGS. 1A-1B are cross-sectional views of a test port interfacing with a coaxial standard.

FIG. 1C is a signal flow graph associated with FIGS. 1A-1B.

FIGS. 2A-2C are flow diagrams of a modeling method according to embodiments of the present invention.

FIGS. 3A-3B are signal flow graphs associating nominal models of the coaxial standards with enhanced models that accommodate for actual pin depths of the coaxial standards.

### DETAILED DESCRIPTION OF THE PREFERRED EMBODIMENTS

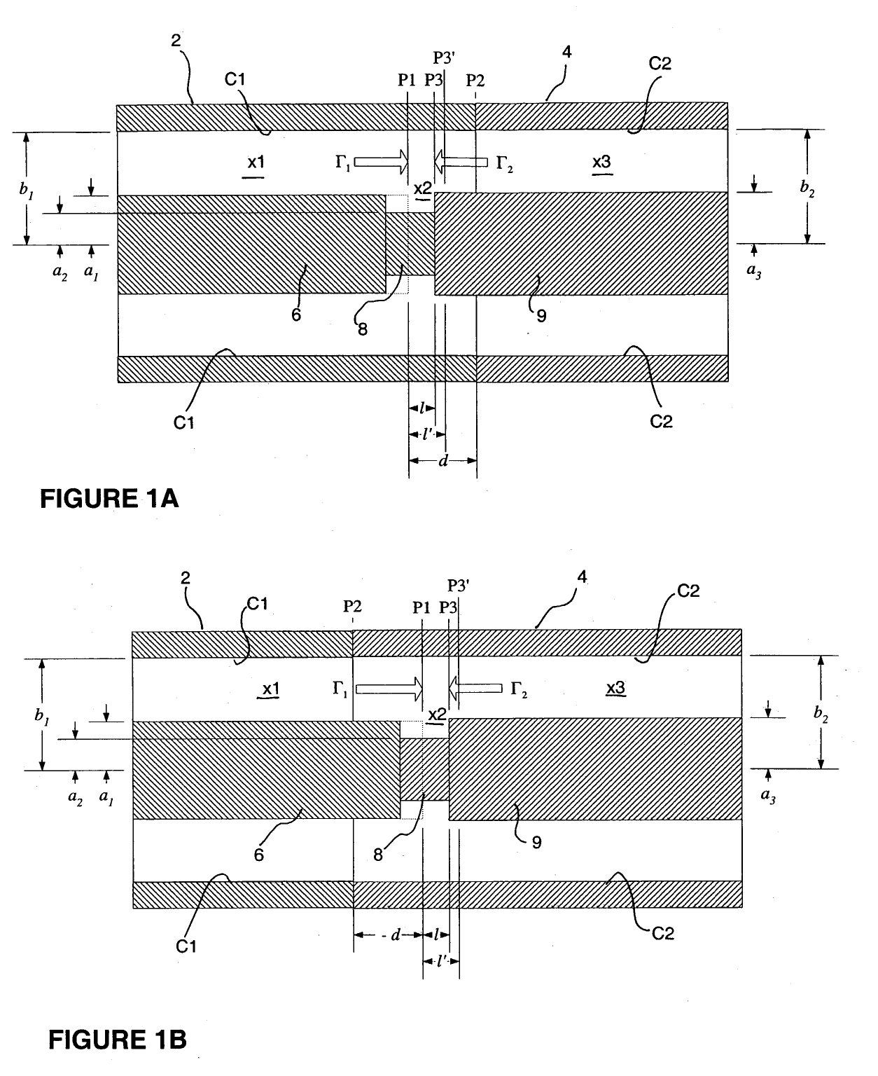

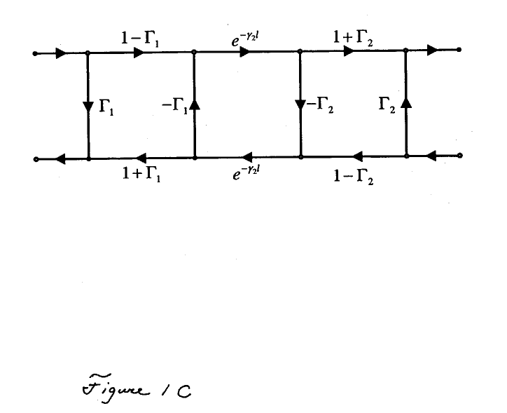

FIGS. 1A-1B show cross-sectional views of a test port 2 interfacing with a coaxial standard 4. Typically, the test port 2 is a coaxial connector of a vector network analyzer or other type of network analysis system (not shown), and the coaxial standard 4 is an open, short, thru, or load used to calibrate the network analysis system. FIG. 1A indicates the coaxial standard 4 having a female termination and the test port 2 having a male termination, whereas FIG. 1B indicates the coaxial standard 4 having a male termination and the test port 2 having a female termination. The test port 2 and the coaxial standard 4 include any of a variety of male and female terminations, such as those based on type N, 1.85 mm, 2.4 mm or 3.5 mm coaxial connection standards.

When the coaxial standard 4 has a female termination and the test port 2 has a male termination, the test port 2 includes a center conductor 6 transitioning to a center pin 8 that penetrates a center conductor 9 of the coaxial standard 4 at a transition plane P3. Alternatively, when the coaxial standard 4 has a male termination and the test port 2 has a female termination, the coaxial standard 4 includes a center conductor 9 transitioning to a center pin 8 at the transition plane P3 that then penetrates a center conductor 6 of the test port 2.

The test port 2 has an outer conductor C1 that mates with an outer conductor C2 of the coaxial standard 4 at an outer conductor mating plane P2. In the example of FIG. 1A, the outer conductor mating plane P2 is offset from the center conductor mating plane P1 by a positive offset d and the center conductor 9 of the coaxial standard 4 protrudes from the outer conductor mating plane P2. In the example of FIG. 1B, the outer conductor mating plane P2 is offset from the center conductor mating plane P1 by a negative offset d and the center conductor 9 of the coaxial standard 4 is recessed from the outer conductor mating plane P2. However, in many types of coaxial standards 4, the outer conductor mating plane P2 and the center conductor mating plane P1 coincide, and the offset d is zero. In a typical network analyzer calibration schemes, vector error correction of the test port 2 compensates for characteristics of the test port 2 up to the center conductor mating plane P1.

The center pin 8 of the coaxial standard 4 has a nominal pin depth 1 that designates a nominal offset between the center conductor mating plane P1 and the nominal transition plane P3, designated as transition plane P3, at which there is a transition from the center pin 8 having radius a2, to the center conductor 9 of the coaxial standard 4 having radius a3. An actual pin depth 1′ of the center pin 8, which is different from the nominal pin depth 1, is also shown. The difference between the nominal pin depth 1 and the actual pin depth 1′ results from the coaxial standard 4 having an actual transition plane P3′ that is offset from the nominal transition plane P3, typically due to dimensional tolerances resulting from the fabrication of the coaxial standard 4. The relative positions of the transition planes P3 and P3′ determine whether the actual pin depth 1′ is longer or shorter than the nominal pin depth 1. In the example shown in FIGS. 1A-1B, the actual pin depth 1′ is greater than the nominal pin depth 1.

Once the actual pin depth 1′ is determined, the difference between the actual pin depth 1′ and the nominal pin depth 1 is accommodated by an enhanced model of the coaxial standard 4 in accordance with the embodiments of the present invention.

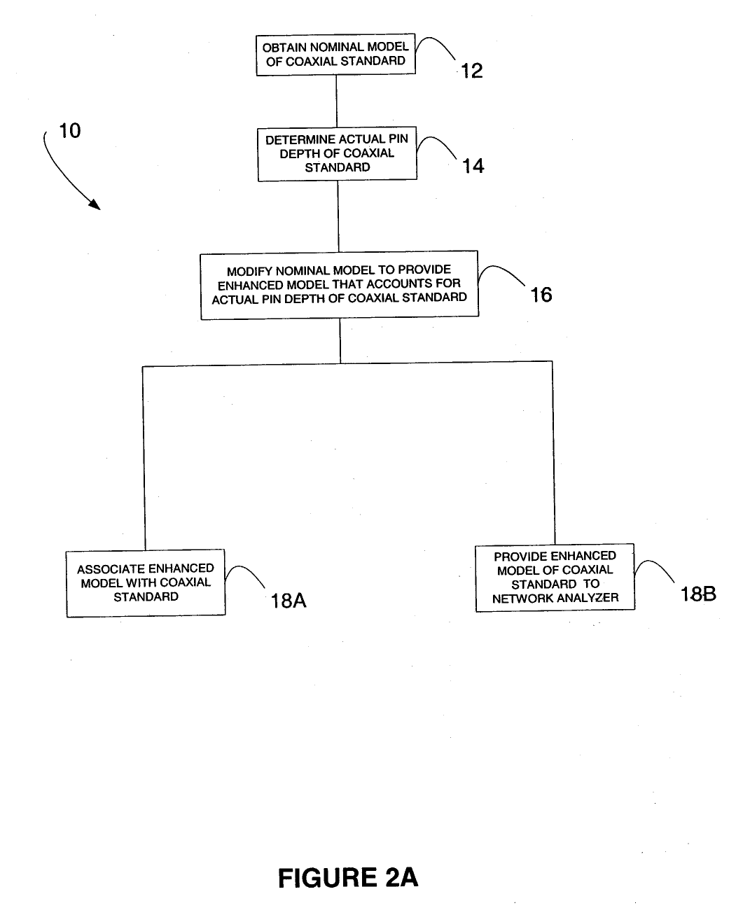

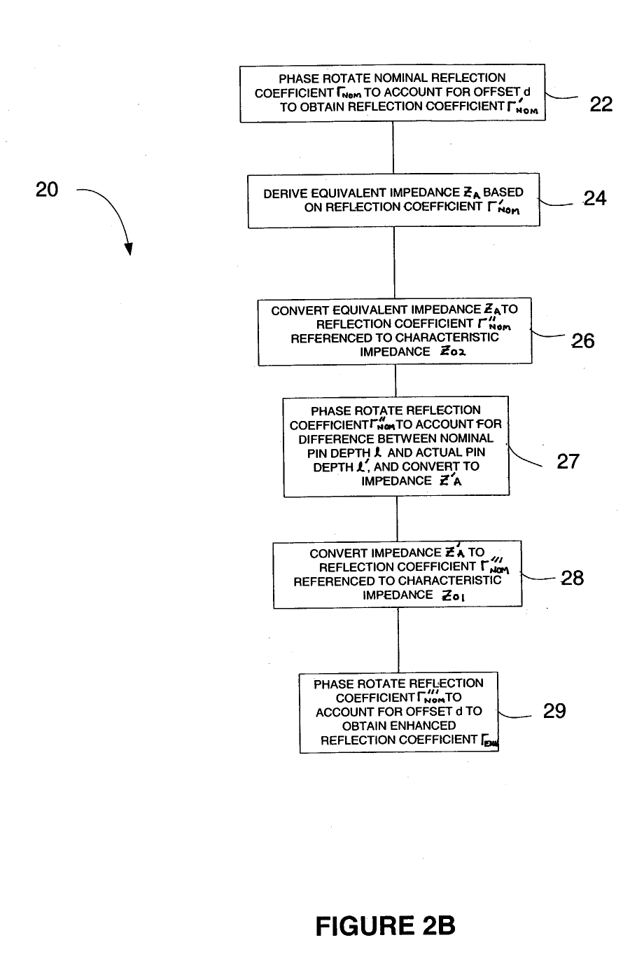

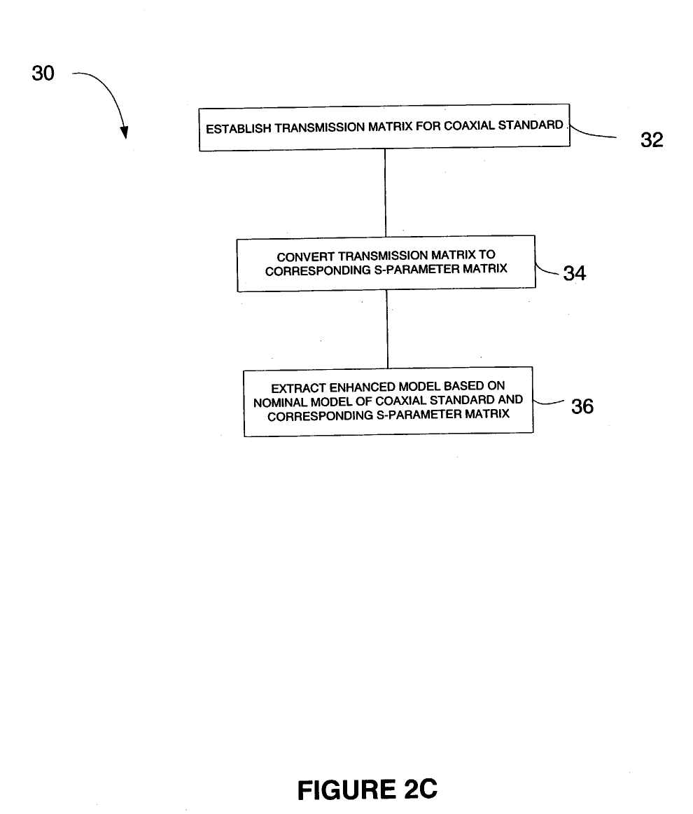

FIG. 2A is a flow diagram of a modeling method 10 in accordance with an embodiment of the present invention. In step 12 of the modeling method 10a nominal model for the coaxial standard is obtained. The nominal model is typically a reflection coefficient Γ_{NOM} for a one-port coaxial standard 4 or an S-parameter matrix S_{NOM} for a thru or other multiport coaxial standard that includes the effects of the nominal pin depth 1. This nominal model is established by a polynomial curve fit, a discrete data point fit with interpolation, or other suitable modeling technique, and is typically provided for each coaxial standard 4 included in a calibration kit, such as the model 85052B Coaxial Cal Kit, by AGILENT TECHNOLOGIES, INC., Palo Alto, Calif.

In step 14 of the method 10, the actual pin depth 1′ is determined from a physical measurement, estimate or other determination of the position of the actual transition plane P3′. In step 16, the nominal model is modified to provide an enhanced model that accounts for the actual pin depth 1′ associated with the coaxial standard. Steps 18A-18B, shown in FIG. 2A are optionally included in the method 10.

FIG. 2B is a flow diagram 20, according to an embodiment of the present invention, indicating steps for modifying the nominal model of the coaxial standard 4 to account for the actual pin depth 1′ of the coaxial standard, according to step 16 of the method 10 in the example where the nominal model is the nominal reflection coefficient Γ_{NOM}. Modifying the nominal reflection coefficient Γ_{NOM} according to the flow diagram 20 results in the enhanced model of the coaxial standard 4 being an enhanced reflection coefficient Γ_{ENH}.

In step 22 of the flow diagram 20, the nominal reflection coefficient Γ_{NOM} is modified to account for the offset d between the outer conductor mating plane P2 and the center conductor mating plane P1. This includes phase rotating the reflection coefficient Γ_{NOM} away from the outer conductor mating plane P2 to obtain a reflection coefficient Γ′_{NOM} indicated by the relationship

Γ_{NOM}=Γ_{NOM}e^{-2jγ}^{₃}^{d}

where γ₃ is a propagation constant for the coaxial standard 4 in the region of the center conductor 9. When the coaxial terminations of the test port 2 and the coaxial standard 4 result in the outer conductor mating plane P2 and the center conductor mating plane P1 being coincident, step 22 is optionally omitted since the offset d is zero.

In step 24, an equivalent impedance Z_{A} is derived, based on the reflection coefficient Γ′_{NOM} according to the relationship Z_{A}=Z₀₁(1+Γ′_{NOM})/(1−Γ′_{NOM}), where Z₀₁ is the characteristic impedance of the test port 2 in the region of the center conductor 6. Typically, the characteristic impedance Z₀₁ is measured, empirically determined, or calculated, for example, based on the permittivity e₁ and permeability u₁ of the dielectric x1 between the center conductor 6 and the outer conductor C1 of the test port 2, the radius al of the center conductor 6, and the inner radius b1 of the outer conductor C1 according to the relationship

$${Z}_{01} = \frac{1}{2 π} \sqrt{\frac{{μ}_{1}}{{e}_{1}}} ln ( \frac{b1}{a1} ) .$$

The equivalent impedance Z_{A} is then converted to a reflection coefficient Γ″_{NOM} in step 26 according to the relationship Γ″_{NOM}=(Z_{A}−Z_{0 2})/(Z_{A}+Z₀₂) , where Z₀₂ is the characteristic impedance of the test port 2 in the region of the center pin 8. Typically, the characteristic impedance Z₀₂ is measured, empirically determined, or calculated, for example, based on the permittivity e₂ and the permeability u₂ of the dielectric x2 between the center pin 8 and the corresponding outer conductor C1, C2 of the test port 2, the radius a2 of the center conductor 8, and the inner radius b1, b2 of the corresponding outer conductor C1, C2 according to the relationship

$${Z}_{02} = \frac{1}{2 π} \sqrt{\frac{{μ}_{2}}{{e}_{2}}} ln ( \frac{b2}{a2} ) .$$

In step 27, the reflection coefficient Γ′_{NOM} is phase rotated away from the nominal transition plane P3 to the actual transition plane P′3 to indicate the difference between the nominal pin depth 1 and the actual pin depth 1′, and is then converted into an impedance Z′_{A} according to the relationship

$${Z}_{A}^{′} = {Z}_{01} \frac{1 + {Γ}_{NOM}^{″} {ⅇ}^{2 j {γ}_{2} ( l - {l}^{′} )}}{1 + {Γ}_{NOM}^{″} {ⅇ}^{2 j {γ}_{2} ( l - {l}^{′} )}}$$

where γ₂ is the propagation constant in the region of the center pin 8.

In step 28, the impedance Z′_{A} is converted to a reflection coefficient Γ′″_{NOM} referenced to the characteristic impedance Z₀₁ of the test port 2, according to the relationship

Γ′″_{NOM}=(Z′_{A}−Z₀₁)/(Z′_{A}+Z₀₁).

In step 29, the reflection coefficient Γ′″_{NOM} is phase rotated toward the outer conductor transition plane P3 to accommodate for the offset d between the outer conductor mating plane P2 and the center conductor mating plane P1, to obtain the enhanced reflection coefficient Γ_{ENH} for the coaxial standard 4 indicated by the relationship

Γ_{ENH}=Γ′″_{NOM}e^{2jγ}^{₁}^{d}.

When the outer conductor mating plane P2 and the center conductor mating plane P1 are coincident, step 29 is optionally omitted since the offset d is zero.

FIG. 2C is a flow diagram 30 according to an alternative embodiment of the present invention indicating steps for modifying the nominal model of the coaxial standard 4 to account for the actual pin depth 1′ of the coaxial standard according to step 16 of the method 10 shown in FIG. 1A. The flow diagram 30 is suitable for determining the enhanced reflection coefficient Γ_{ENH} from the nominal coefficient Γ_{NOM} when the coaxial standard 4 has one port, and suitable for determining the S-parameter matrix S_{ENH} from the nominal S-parameter matrix S_{NOM} when the coaxial standard 4 has multiple ports.

In step 32 of the flow diagram 30, a total transmission matrix, designated as transmission matrix Tt, for the coaxial standard 4 is established. Typically, transmission matrices are wave amplitude transmission matrices formulated so that output terms from one junction of a network are inputs to the next adjacent junction of the network, thus enabling the cascading of network elements to be represented by matrix multiplication of wave amplitude transmission matrices corresponding to the network elements. In step 34, the transmission matrix for the coaxial standard is converted to a corresponding S-parameter matrix St using known techniques for converting between S-parameter matrices and transmission parameter matrices, such as those described in Foundations for Microwave Engineering, Collin, R. E., McGraw-Hill, 1966, pages 181-182, hereby incorporated by reference. In step 36, the enhanced model represented as either Γ_{ENH} or S_{ENH}, is extracted from the S-parameter matrix St.

According to step 32, the transmission matrix Tt is established according to the matrix relationship

[Tₜ]=[T′_{d}]•[T′_{PACTUAL}]•[T_{δ}]•[T_{PNOM}]⁻¹•[T_{d}]⁻¹ (1)

where the superscript “−1” designates a matrix inverse operator. The transmission matrix Td⁻¹ in equation (1) removes the effect of the offset d between the center conductor mating plane P1 and the outer conductor mating plane P2. The transmission matrix Td is derived from an S-parameter matrix Sd using known matrix conversion techniques, where the S-parameter matrix Sd is represented by the relationship

$${S}_{d} = [ \begin{matrix}0 & {ⅇ}^{- {r}_{1} d} \\ {ⅇ}^{- {r}_{1} d} & 0\end{matrix} ]$$

and where γ₁ is the propagation constant in the region of the test port 2.

The transmission matrix T_{PNOM}⁻¹ in equation (1) removes the effect of the nominal pin gap 1 and is obtained from an S-parameter matrix S_{PNOM} using known matrix conversion techniques. The S-parameter matrix S_{PNOM} is represented by the relationship

$${S}_{PNOM} = [ \begin{matrix}{S11}_{PNOM} & {S12}_{PNOM} \\ {S21}_{PNOM} & {S22}_{PNOM}\end{matrix} ]$$

e the signal flow graph of FIG. 1C is used to obtain the terms in the S-parameter matrix S_{PNOM} as:

$$\begin{matrix}{S11}_{PNOM} = {Γ}_{1} - \frac{{Γ}_{2} {ⅇ}^{- 2 {γ}_{2} l}}{1 - {Γ}_{1} {Γ}_{2} {ⅇ}^{- 2 {γ}_{2} l}} ; \\ {S21}_{PNOM} = \frac{{ⅇ}^{- {γ}_{2} l}}{1 - {Γ}_{1} {Γ}_{2} {ⅇ}^{- 2 {γ}_{2} l}} ; \\ {S12}_{PNOM} = \frac{{ⅇ}^{- {γ}_{2} l}}{1 - {Γ}_{1} {Γ}_{2} {ⅇ}^{- 2 {γ}_{2} l}} ; and \\ {S22}_{PNOM} = {Γ}_{2} - \frac{{Γ}_{1} {ⅇ}^{- 2 {γ}_{2} l}}{1 - {Γ}_{1} {Γ}_{2} {ⅇ}^{- 2 {γ}_{2} l}} ;\end{matrix}$$

and where Γ₁ is the match at the transition between the center conductor of the test port and the center pin, and Γ₂ is the match at the transition between the center conductor of the coaxial standard and the center pin as shown in FIGS. 1A-1B.

The transmission matrix T_{δ} in equation (1) accomodates for the difference between the nominal pin depth 1 and the actual pin depth 1′. The transmission matrix T_{δ} is obtained from an S-parameter matrix S_{δ} using known matrix conversion techniques where the S-parameter matrix S_{δ} is represented by the relationship

$${S}_{δ} = [ \begin{matrix}0 & {ⅇ}^{{γ}_{3} ( {l}^{′} - l )} \\ {ⅇ}^{{γ}_{3} ( {l}^{′} - l )} & 0\end{matrix} ] .$$

The transmission matrix T_{PACTUAL} in equation (1) adds the effect of the actual pin gap 1′ at discontinuities between the center pin 8 between the center conductor 6 of the test port 2 and the center conductor 9 of the coaxial standard 4. The transmission matrix T_{PACTUAL} is also obtained from an S-parameter matrix S_{PACTUAL} using matrix conversion techniques between S-parameters and transmission parameters. The S-parameter matrix S_{PACTUAL} is represented by the relationship

$$\begin{matrix}{S}_{PACTUAL} = [ \begin{matrix}{S11}_{PACTUAL} & {S12}_{PACTUAL} \\ {S21}_{PACTUAL} & {S22}_{PACTUAL}\end{matrix} ] \\ where {S11}_{PACTUAL} = {Γ}_{1} - \frac{{Γ}_{2} {ⅇ}^{- 2 {γ}_{2} {l}^{′}}}{1 - {Γ}_{1} {Γ}_{2} {ⅇ}^{- 2 {γ}_{2} {l}^{′}}} ; \\ {S21}_{PACTUAL} = \frac{{ⅇ}^{- {γ}_{2} {l}^{′}}}{1 - {Γ}_{1} {Γ}_{2} {ⅇ}^{- 2 {γ}_{2} {l}^{′}}} ; \\ {S12}_{PACTUAL} = \frac{{ⅇ}^{- {γ}_{2} {l}^{′}}}{1 - {Γ}_{1} {Γ}_{2} {ⅇ}^{- 2 {γ}_{2} {l}^{′}}} ; and \\ {S22}_{PACTUAL} = {Γ}_{2} - \frac{{Γ}_{1} {ⅇ}^{- 2 {γ}_{2} {l}^{′}}}{1 - {Γ}_{1} {Γ}_{2} {ⅇ}^{- 2 {γ}_{2} {l}^{′}}} .\end{matrix}$$

The transmission matrix T′_{d} in equation (1) adds the effect of the offset d between the center conductor mating plane P1 and the outer conductor mating plane P2. The transmission matrix T′_{d} is obtained from an S-parameter matrix S′_{d} using known matrix conversion techniques between S-parameters and transmission parameters. The S-parameter matrix S′_{d} is represented by the relationship

$${S}_{d}^{′} = [ \begin{matrix}0 & {ⅇ}^{- {γ}_{1} d} \\ {ⅇ}^{- {γ}_{1} d} & 0\end{matrix} ] .$$

In step 34 of the flow diagram 30, the transmission matrix Tt for the coaxial standard 4 is converted to an S-parameter matrix St using known conversion techniques, where the resulting S-parameter matrix St is represented by the relationship:

$${S}_{t} = [ \begin{matrix}{S11}_{t} & {S12}_{t} \\ {S21}_{t} & {S22}_{t}\end{matrix} ]$$

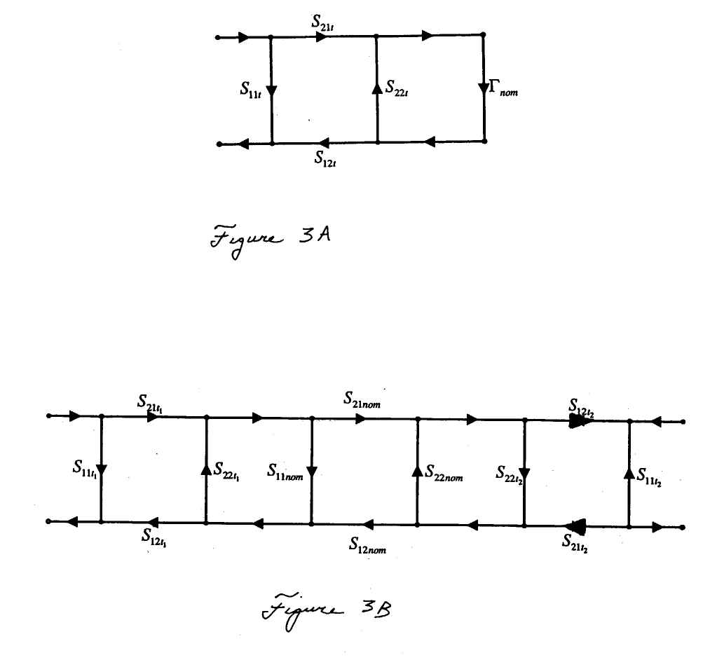

In step 36, the enhanced model, for example the enhanced reflection coefficient Γ_{ENH} or the enhanced S-parameter matrix S_{ENH}, is extracted from the S-parameter matrix St. FIG. 3A shows a signal flow graph associating the S-parameter matrix St with the enhanced model Γ_{ENH} for the coaxial standard, for the example where the coaxial standard has one-port. From the signal flow graph, or any suitable network analysis technique, the enhanced model Γ_{ENH} for the coaxial standard is determined according to the relationship

$${Γ}_{ENH} = {S11}_{t} + \frac{{S22}_{t} {S12}_{t}}{1 - {S22}_{t} {Γ}_{NOM}}$$

FIG. 3B shows a signal flow graph associating the S-parameter matrix St with the enhanced model for the coaxial standard 4 having two ports, where the enhanced model is the S-parameter matrix S_{ENH}. From the signal flow graph, or other suitable network analysis technique, the enhanced model S_{ENH} for the coaxial standard 4 is determined according to the relationship

$${S}_{ENH} = [ \begin{matrix}{S11}_{ENH} & {S12}_{ENH} \\ {S21}_{ENH} & {S22}_{ENH}\end{matrix} ]$$

$$where$$

$${S11}_{ENH} = {S11}_{t1} + \frac{\begin{matrix}{S11}_{NOM} {S21}_{t1} {S12}_{t1} ( 1 - {S22}_{t2} {S22}_{NOM} ) + \\ {S21}_{t1} {S12}_{t1} {S21}_{NOM} {S12}_{NOM} {S22}_{t2}\end{matrix}}{\begin{matrix}1 - {S22}_{t1} {S11}_{NOM} - {S22}_{t2} {S22}_{NOM} + \\ {S22}_{t1} {S22}_{t2} ( {S11}_{NOM} {S22}_{NOM} {\_S21}_{NOM} {S12}_{NOM} )\end{matrix}} ;$$

$${S21}_{ENH} = \frac{{S21}_{t1} {S21}_{NOM} {S12}_{t2}}{\begin{matrix}1 - {S22}_{t1} {S11}_{NOM} - {S22}_{t2} {S22}_{NOM} + \\ {S22}_{t1} {S22}_{t2} ( {S11}_{NOM} {S22}_{NOM} {\_S21}_{NOM} {S12}_{NOM} )\end{matrix}} ;$$

$${S12}_{ENH} = \frac{{S21}_{t2} {S12}_{NOM} {S12}_{t1}}{\begin{matrix}1 - {S22}_{t1} {S11}_{NOM} - {S22}_{t2} {S22}_{NOM} + \\ {S22}_{t1} {S22}_{t2} ( {S11}_{NOM} {S22}_{NOM} {\_S21}_{NOM} {S12}_{NOM} )\end{matrix}} ;$$

$${S22}_{ENH} = {S11}_{t1} + \frac{\begin{matrix}{S22}_{NOM} {S21}_{t2} {S12}_{t2} ( 1 - {S22}_{t1} {S11}_{NOM} ) + \\ {S21}_{t2} {S12}_{t2} {S21}_{NOM} {S12}_{NOM} {S22}_{t1}\end{matrix}}{\begin{matrix}1 - {S22}_{t1} {S11}_{NOM} - {S22}_{t2} {S22}_{NOM} + \\ {S22}_{t1} {S22}_{t2} ( {S11}_{NOM} {S22}_{NOM} {\_S21}_{NOM} {S12}_{NOM} )\end{matrix}} .$$

The subscript “t1” designates S-parameter elements of an S-parameter matrix St1 for the first port of the two-port coaxial standard, and the subscript “t2” represents S-parameter elements of an S-parameter matrix St2 for the second port of the two-port coaxial standard 4.

The enhanced models Γ_{ENH}, S_{ENH} for the coaxial standard 4 have improved accuracy relative to the nominal model obtained in step 12 of the modeling method 10, since the enhanced model accounts for the actual pin depth 1′ associated with the coaxial standard 4 as determined in step 14. When the coaxial standard 4 has one-port, such as an open, short or load standard, the enhanced model for the coaxial standard 4 is suitably represented by the enhanced reflection coefficient Γ_{ENH}. When the coaxial standard 4 has more than one port, such as thru standard, the enhanced model is suitable represented by an S-parameter matrix S_{ENH}.

Steps 12-16 of the modeling method 10 are typically repeated for each coaxial standard 4 used in calibrating a network analyzer so that error correction terms established during calibration of a network analyzer can be more accurately determined. For example, in optional step 18A of the method 10 the enhanced model is associated with a corresponding coaxial standard 4, for example the one or more coaxial standards included in a calibration kit used to calibrate a network analyzer. Typically, the enhanced models are provided in a memory or storage medium that is readable by the network analyzer, or that is capable of being downloaded to the network analyzer. In optional step 18B, the enhanced model for each coaxial standard 4 is provided to the network analyzer from a computer or network connection.

The enhanced models Γ_{ENH}, S_{ENH} for the coaxial standard 4 are suitable for use by a network analyzer to calibrate the network analyzer according to various S-parameter calibration methods that are known in the art, such as those taught in an Application Note AN-1287-3, by AGILIENT TECHNOLOGIES, INC., of Palo Alto, Calif., USA or according to other known network analyzer calibration techniques, such as those of the E8361A network analyzer by AGILIENT TECHNOLOGIES, INC. Typical calibration techniques involve measuring the response characteristics of one or more coaxial standards, accessing a model of the coaxial standard, and using the measured response characteristics and the accessed model of the coaxial standard to solve for error correction terms, such as directivity terms, tracking terms and matches, that provide the calibration. When the enhanced models of the coaxial standards are accessed and used in these calibration techniques in place of the nominal models of the coaxial standards, the error correction terms are more accurately determined-especially at high frequencies, since the enhanced models account for the actual pin depth associated with the particular coaxial standards used in the calibration.

While the embodiments of the present invention have been illustrated in detail, it should be apparent that modifications and adaptations to these embodiments may occur to one skilled in the art without departing from the scope of the present invention as set forth in the following claims.

What is claimed is:

1. A method for modeling a coaxial standard, comprising:
obtaining a nominal model of the coaxial standard;
determining an actual pin depth associated with the coaxial standard; and
modifying the nominal model for the coaxial standard to provide an enhanced model for the coaxial standard that accounts for the actual pin depth associated with the coaxial standard.

2. The method of claim 1 wherein the nominal model includes a nominal reflection coefficient of the coaxial standard having an associated nominal pin depth.

3. The method of claim 2 wherein modifying the nominal model includes deriving a first impedance based on the nominal reflection coefficient, converting the first impedance to a second reflection coefficient, phase rotating the second reflection coefficient to account for a difference between the nominal pin depth and the actual pin depth associated with the coaxial standard, converting the phase rotated second reflection coefficient to a second impedance, and deriving an enhanced reflection coefficient from the second impedance referenced to a characteristic impedance of a test port.

4. The method of claim 2 wherein modifying the nominal model includes phase rotating the nominal reflection coefficient to account for an offset between an outer conductor mating plane between a test port and the coaxial standard and a center conductor mating plane between the test port and the coaxial standard to obtain a second reflection coefficient, deriving a first impedance based on the second reflection coefficient, converting the first impedance to a third reflection coefficient, phase rotating the third reflection coefficient to account for a difference between the nominal pin depth and the actual pin depth associated with the coaxial standard, converting the phase rotated third reflection coefficient to a second impedance, deriving a fourth reflection coefficient based on the second impedance, referenced to a characteristic impedance of the test port, and phase rotating the fourth reflection coefficient to account for the offset between the outer conductor mating plane and the center conductor mating plane to obtain an enhanced reflection coefficient of the coaxial standard.

5. The method of claim 1 wherein modifying the nominal model includes establishing a transmission matrix for the coaxial standard, converting the transmission matrix to a corresponding S-parameter matrix, and extracting the enhanced model for the coaxial standard based on the nominal model and the S-parameter matrix.

6. The method of claim 5 wherein the enhanced model is an enhanced reflection coefficient.

7. The method of claim 5 wherein the enhanced model is an enhanced S-parameter matrix.

8. The method of claim 1 further comprising associating the enhanced model for the coaxial standard with a calibration kit.

9. The method of claim 1 further comprising providing the enhanced model for the coaxial standard to a network analyzer.

10. The method of claim 1 wherein the enhanced model for the coaxial standard is stored in at least one of a memory or storage medium.

11. The method of claim 3 wherein the enhanced model for the coaxial standard is stored in at least one of a memory or storage medium.

12. The method of claim 5 wherein the enhanced model for the coaxial standard is stored in at least one of a memory or storage medium.

13. A method for modeling a coaxial standard at a test port of a network analyzer, comprising:
obtaining a nominal model for the coaxial standard wherein the coaxial standard is designated to have a nominal pin depth, the nominal model based on at least one of a polynomial fit and a discrete data point fit with interpolation;
determining an actual pin depth associated with the coaxial standard;
modifying the nominal model for the coaxial standard to provide an enhanced model for the coaxial standard that accounts for the actual pin depth associated with the coaxial standard; and
using the enhanced model to calibrate the network analyzer.

14. The method of claim 13 wherein modifying the nominal model includes deriving a first impedance based on the nominal reflection coefficient, converting the first impedance to a second reflection coefficient, phase rotating the second reflection coefficient to account for a difference between the nominal pin depth and the actual pin depth associated with the coaxial standard, converting the phase rotated second reflection coefficient to a second impedance, and deriving an enhanced reflection coefficient from the second impedance referenced to a characteristic impedance of the test port of the network analyzer.

15. The method of claim 13 wherein modifying the nominal model includes establishing a transmission matrix for the coaxial standard, converting the transmission matrix to a corresponding S-parameter matrix, and extracting the enhanced model for the coaxial standard based on the nominal model and the S-parameter matrix.

16. The method of claim 15 wherein the enhanced model is an enhanced reflection coefficient.

17. The method of claim 15 wherein the enhanced model is an enhanced S-parameter matrix.

18. A computer-readable medium encoded with a computer program that instructs a computer to perform a method for modeling a coaxial standard, the method comprising:
obtaining a nominal model of the coaxial standard;
determining an actual pin depth associated with the coaxial standard; and
modifying the nominal model for the coaxial standard to provide an enhanced model for the coaxial standard that accounts for the actual pin depth associated with the coaxial standard.

19. The computer-readable medium of claim 18 wherein modifying the nominal model includes deriving a first impedance based on the nominal reflection coefficient, converting the first impedance to a second reflection coefficient, phase rotating the second reflection coefficient to account for a difference between the nominal pin depth and the actual pin depth associated with the coaxial standard, converting the phase rotated second reflection coefficient to a second impedance, and deriving an enhanced reflection coefficient from the second impedance referenced to a characteristic impedance of a test port.

20. The computer-readable medium of claim 18 wherein modifying the nominal model includes establishing a transmission matrix for the coaxial standard, converting the transmission matrix to a corresponding S-parameter matrix, and extracting the enhanced model for the coaxial standard based on the nominal model and the S-parameter matrix.
